(19) United States
(12) Patent Application Publication
(10) Pub. No.: US 2012/0143436 A1
(43) Pub. Date: Jun. 7, 2012

(54) Monitoring Device for Aircraft Equipment

(76) Inventors: Albert Cornet, Verviers (BE); Nicolas Doucet, Saint-Georges sur Meuse (BE); Philippe Langohr, Crisnee (BE); Matthieu Droeller, Liege (BE); Nicolas Raimarckers, Tourine (Braives) (BE); Fabrice Haudry, Battice (BE); Michel Saint-Mard, Cheratte (BE); Rémy Leblond, Etterbeek (BE)

(21) Appl. No.: 13/307,177

(22) Filed: Nov. 30, 2011

(30) Foreign Application Priority Data
Dec. 2, 2010 (EP) 10193525.2

(51) Int. Cl. G01M 17/00

(52) U.S. Cl. 701/33.4

(57) ABSTRACT

A device for monitoring aircraft equipment is adapted to be arranged on said equipment and to measure and memorize at least one operation parameter of said equipment. The monitoring device is configured to be activated only in the presence of one or more parameters, representative of said equipment.

This application claims priority under 35 U.S.C. §119 to European Patent Application No. EP 10193525.2, filed 2 Dec. 2010, which is incorporated herein by reference for all purposes.

### BACKGROUND

1. Field of the Application

The present application relates to a device for monitoring aircraft equipment, more particularly to a device for monitoring an item of equipment adapted to be arranged on the equipment per se. The invention also relates to aircraft equipment provided with said monitoring device.

2. Description of Related Art

In numerous technical fields, particularly the fields in which people interact with complex technical equipment susceptible to hindering their safety, such as, activities of public transportation, but more particularly the aeronautical field, the maintenance of the technical equipment per se has a direct impact on people's safety. Aircraft equipment comprise numerous items of equipment susceptible of failing and, consequently, requiring specific maintenance. The maintenance frequencies of these various items of equipment vary as a function of various parameters of use. It is therefore useful to be able to measure the life and use parameters of the equipment in order to be able to provide an optimal maintenance and guarantee public safety.

The patent document US 2003/0083794 A1 discloses a diagnostic system for aircraft equipment essentially comprising a series of sensors arranged on or in the vicinity of the aircraft equipment adapted to measure different operating parameters of the equipment per se, and a common receiver adapted to communicate with the sensors and to receive the data, relative to the operation parameters measured by the sensors and all, in the purpose of diagnosis and maintenance of the equipment. The sensors comprise a source of electric energy, a printed circuit of the micro-controller type, and a transmitter/receiver. The receiver comprises essentially a transmitter/receiver adapted to communicate with the sensors, a display, control means, and a microcontroller. The sensors can be of the passive type, i.e., working without energy source per se. They are thus electrically fed by the energy received from the interrogation signal emitted by the receiver. The diagnosis system disclosed in this document is particularly suitable to carry out occasional checks of different equipment such as, for example, the operational state of the equipment before take-off. The monitoring carried out by the sensors is essentially limited to the operating state of the equipment in order to detect operational malfunctions. The parameters usually monitored are in particular vibrations, pressures, liquid levels, etc. This teaching does not really provide a function for monitoring operational conditions of the equipment from the perspective of their history all along their lifespan.

The patent document WO 2005/111949 A1 discloses a device for monitoring the operation of an item of aircraft equipment. The device is arranged in the vicinity of the equipment and comprises a processor, a memory, a linking interface with different sensors arranged at various places of the equipment and a communication interface with the outside. The device is adapted to collect data from the different sensors during a test procedure and to compare the measurements obtained in real time during the operational functioning of the aircraft with these test measurements referred to as reference tests, and this in order to be able to determine the need for a maintenance of said equipment. The example of equipment, subject to monitoring is a starter motor of an air turbine and the operation parameters which are measured are, in particular, the torque, speed, vibrations, flexion distortion and torsion distortion. The memory of the monitoring device stores the data of the various measurement points or equipment, these data being measured in real time in its memory. The monitoring device is, in principle, an external accessory of the equipment but can also be integrated into the equipment per se. Although the device is provided with a memory, it is still essentially intended to process the data measured in real time and to produce a maintenance report or analysis and also a logistical analysis relative to the components required for the maintenance per se. This teaching does not tackle the issue of the ability of the memory to preserve a history of the equipment.

The patent document FR 2909792 A1 tackles this issue of aircraft equipment maintenance and discloses the presence of a monitoring device having a memory and taken aboard on an LRU-type of equipment (Line Replaceable Unit), focused on the centralization of the monitoring, without really providing further detail as to the device per se.

Currently, the history of the equipment (in particular LRUs) is traced manually and the level of detail is left to the discretion of the airline. It is often difficult to trace the life of the equipment which can have been placed on different aircrafts/engines. Therefore, during maintenance, it is difficult for the airline to know whether it is relevant to send this equipment back to be inspected and repaired. It is even more difficult for the maintenance company to know the history of the equipment, thus requiring the complete disassembly of the equipment before being able to make a decision on the pieces to be purchased for its repair and preventing any inventory management optimization. Recording the parameters of the equipment life would enable a coordinated management of the maintenance and a cost reduction.

Recording the parameters of the equipment life would also allow the design of future generations of equipment to be optimized. Incomplete information of the life of the equipment does not allow its designer to take advantage of all the feedback from maintenance. Recording the parameters of the equipment life allow for filling statistical databases and thus for quantifying the actual reliability rates as well as for identifying and quantifying the causes for repairs to be made on the equipment and to enhance the design of the future generations.

Although great strides have been made in the area of monitoring devices for aircraft equipment, many shortcomings remain.

### DESCRIPTION OF THE DRAWINGS

FIG. 1 is a simplified view of a dual-flow axial turbomachine provided with lubrication equipment subject to monitoring according to the present application.

FIG. 2 is a schematic view of the lubrication equipment of the turbomachine of FIG. 1 provided with a monitoring equipment according to the present application.

FIG. 3 is an enlarged view of the monitoring device of FIG. 2 according to the present application.

FIG. 4 shows the architecture of the monitoring device according to the present application.

### DETAILED DESCRIPTION OF THE PREFERRED EMBODIMENT

The present application provides a monitoring device for an aircraft equipment overcoming at least one of the aforementioned drawbacks, more particularly a monitoring device for an aircraft equipment allowing for tracing the history of the equipment over a given period of time or number of cycles and particularly over the lifespan (typically of 50,000 hours or 50,000 cycles), and particularly adapted to be integrated into said equipment.

The present application provides a monitoring device for an aircraft equipment intended to be taken on board said equipment, comprising: an electric energy source; at least one sensor adapted to measure an operation parameter of said equipment; a microcontroller; a memory adapted to store the values measured by said sensor; characterized in that said device is configured to be placed automatically in operation only in the presence of one or more parameters representative of the operation of said equipment. The device is also configured to be automatically deactivated in the absence of said parameter or parameters, during a predetermined period.

The source of energy is preferably electric. It preferably has enough capacity for the device to function.

Preferably, the automatic activation of the monitoring device, its operation and/or deactivation, take place in the absence of an electric connection with the outside of the device.

These particular measures make it possible to ensure a function referred to as “snitch” with limited memory and energy source, that is, with low cost means and a small space requirement. In addition, they also allow for determining the length of the cycles and the number of accrued hours of service of the equipment.

Advantageously, the parameter or parameters representative of the operation of the equipment comprise temperature and/or vibrations. Indeed, these parameters are particularly representative of the operation of the equipment, and more particularly of the load level of their operation.

Advantageously, the device comprises a vibration sensor used as a parameter for activating the device. In this case, by way of example, the device is activated when the equipment is subjected to a vibration level corresponding to an operation under load beyond a determined level. The vibration triggering threshold can be in the area of the amplitude measured at the level of the frequencies or at the level of a combination of both.

Advantageously, the vibration sensor is configured to detect at least one determined frequency range. This is interesting when this frequency range corresponds, for example, to a speed referred to as slowed-down or “idle” of the equipment, since this makes it possible to determine each operation cycle.

Advantageously, the device comprises a temperature sensor used as a parameter for activating the device.

Advantageously, the energy source comprises a thermo-generator. Such thermo-generator enables the device to be autonomous. It is thus supplied with current particularly when it is susceptible to being activated.

Advantageously, the thermo-generator ensures the activation of the device on the basis of a temperature parameter. It is a simple and effective configuration of the device. Reaching a given temperature level provides the necessary electric supply and the activation.

Advantageously, the device comprises a vibration sensor ensuring the activation of the device on the basis of a vibration parameter.

Advantageously, the source of energy comprises, in addition, a piezoelectric generator.

Advantageously, the device comprises connectors adapted to enable a transfer of information stored in the memory to an external apparatus.

Advantageously, the device is passive from the standpoint of the emission of wavelengths. This measure is particularly interesting insofar as the device is adapted to remain on the equipment throughout the equipment life. The passivity of the device allows possible problems of electromagnetic compatibility with the environment of the equipment to be avoided, on the aircraft and/or on the ground.

Advantageously, the device comprises a support housing the components of said device.

Advantageously, the support comprises a visible metal part adapted to receive an identification plate of the device and/or of the equipment. Alternatively, the identification is present directly on the support, such as, for example, by engraving.

Advantageously, the support comprises an assembly surface of the equipment, said surface being metallic and directly supporting the sensor adapted to measure an operation parameter of said equipment, said sensor being chosen from among temperature and vibration sensors. The metal support ensures an optimal transmission of the vibration and heat.

Another object of the invention is an aircraft equipment comprising a device such as previously defined.

Advantageously, the aircraft equipment has at least one frequency of its own, and the monitoring device comprises a vibration sensor adapted to detect a frequency range comprising said own frequency of said equipment. The sensor will thus be configured to detect an operation cycle of the equipment when the adequate amplitude has been reached.

### LIST OF REFERENCE NUMERALS

2: turbomachine of the dual-flow turbojet engine type;
4: lubrication equipment;
6: device for monitoring the equipment;
8: oil reservoir;
10: oil management unit of the equipment;
12: pump;
14: air/oil separator;
16: surface of the support of the equipment monitoring device adapted to receive the identification plate;
18: identification plate of the equipment;
22: microcontroller;
24: memory;
26: electric energy generator;
28: vibration and/or temperature sensor;
30: connection interface.

The description that follows is an exemplary embodiment of the present application applied to a lubrication system of a dual-flow turbomachine of the aircraft engine type. It is to be understood that this application is purely exemplary and that the present application can be applied to other items of equipment such as an engine as well as to various aircraft equipment independent of the engine, such as, for example, hydraulic systems for controlling elements of an aircraft.

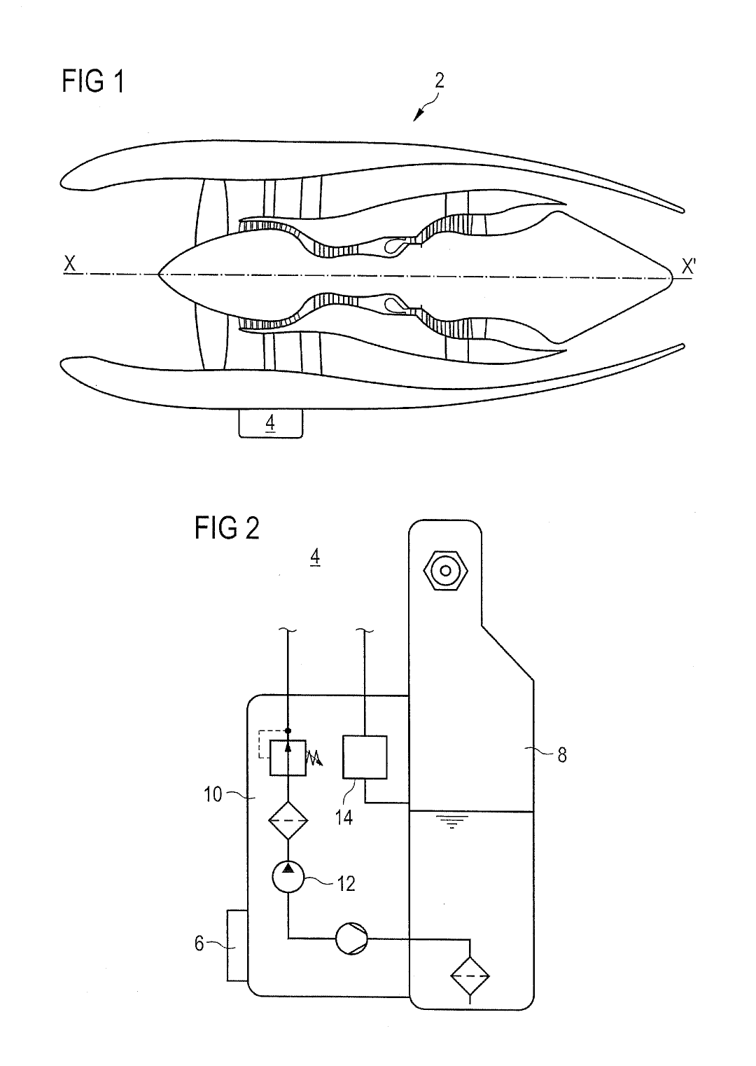

FIG. 1 shows a dual-flow turbomachine of the aircraft engine type 2 known to one having ordinary skill in the art. This aircraft engine 2 is provided with a series of equipment including, in particular, a lubrication equipment 4. Indeed, the aircraft engine comprises a rotor rotating around the axis X-X′ by means of bearings subjecting more or less important loads and requiring lubrication and possibly also cooling.

The lubrication equipment 4 conventionally comprises an oil reservoir 4 and a unit 10 for managing the oil of the equipment and comprising, among others, a pump 12, filtration and regulation means of the output pressure, an oil output connector, an oil return connector and an air/oil separator.

A monitoring device 6 conforming to the invention is arranged on an outer wall of the equipment, more particularly a wall of the oil management unit of the equipment. This wall allows a great amount of information relative to the operation of the equipment to be collected, such as, in particular, the operation temperature and the vibrations thereof. As a function of the various engine speeds, the pump and the other components are indeed subjected to variable operation speeds, temperature, and vibration constraints.

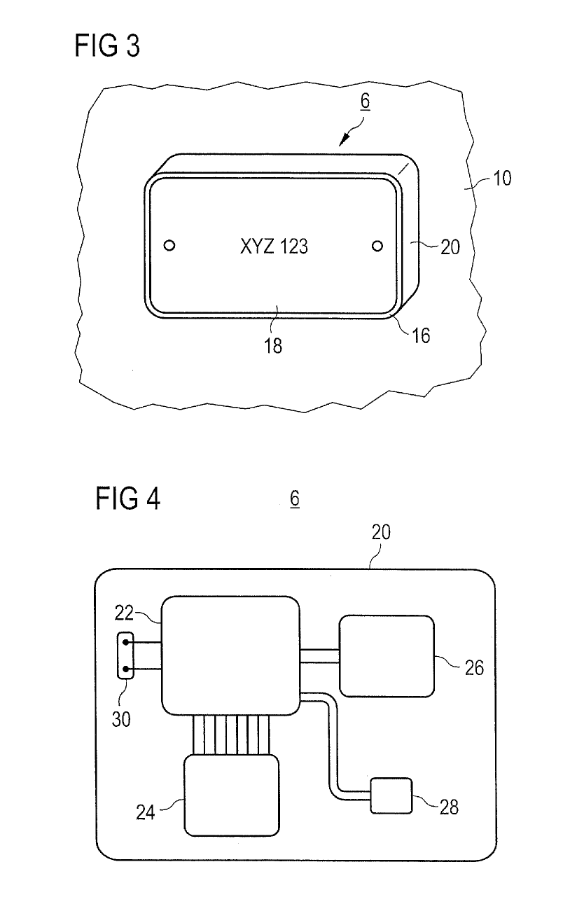

FIG. 3 is an enlarged view of the monitoring device 6. Its shape is generally that of a small-sized parallelepiped, conventionally on the order of one or several centimeters widthwise and a few millimeters thickness wise. It preferably comprises a support 20 used as a housing or box for these components. The support comprises an outer surface 16 predominantly or even entirely covered with an identification plate 18 of the equipment. This way, the monitoring device is intimately associated with the equipment and identifiable by means of the identification of the equipment.

An exemplary structure of the monitoring device 6 of FIGS. 2 and 3 is shown in FIG. 4. It comprises inside of the support 20 at least one sensor 28 adapted to measure an operation parameter of the equipment. This or these sensor(s) 28 can take diverse forms and be of various origins. Typically, the device comprises a vibration sensor and/or temperature sensor. Indeed, these two parameters are part of the most representative parameters of the operation of numerous aircraft equipment.

The monitoring device 6 also comprises a microcontroller 22, a memory 24, an electric energy generator 26 and a connection interface 30. The electric energy source 26 makes it possible to electrically supply the device, particularly the microcontroller 22. The memory 24 allows for storing the data relative to the parameters measured by the sensor or sensors 28.

The electric energy source can be of the thermo-generator type. A thermo-generator uses the thermoelectric effect which is a physical phenomenon present in certain materials connecting the heat flux which passes through them to the electric current which passes through them. This effect gives the possibility of converting a heat flux into electric current and allows for electricity-generating applications from sources of lost heat. The conversion systems using the thermoelectric effect have, however, low yields, whether in terms of electricity or refrigerating generation. This low yield sometimes allows for very advantageously supplying a monitoring device which consumes very little electric energy.

By way of example, a thermo-generating module can be constituted of electrically connected “couples”. Each of the couples is constituted of a semi-conductor material of the p type and of a semi-conductor material of the n type. These two materials are joined by a conductor material whose thermo-electric power is supposed to be null. The two branches (p and n) of the couple and all the other couples making the module are electrically connected in series and thermally connected in parallel. This arrangement makes it possible to optimize the thermal flux which traverses the module and its electric resistance. The load carriers (electrons and holes) move from the cold source to the heat source (in the thermodynamic sense) in the two branches of each couple. The heat flux thus triggers a displacement of the load carriers and thus the appearance of an electric current.

Alternatively or complementarily, it can also be of the piezoelectric type. The principle of a piezoelectric generator is based on piezoelectricity, which is the property that certain bodies have of electrically polarizing under the action of a mechanical constraint and reciprocally of deforming when an electric field is applied to them. In the case of the piezoelectric generator, the vibrations of the equipment make it possible to compress and decompress one or more elements made of piezoelectric material and, consequently, to generate, for example by means of an integrated smoothing circuit, a source of electric current adapted to supply or co-supply the thermoelectric generator the monitoring device.

The device is configured to be automatically actuated only in the presence of one or more parameters representative of the operation of the equipment, such as, for example, a minimum temperature or a predetermined vibration level. This on-demand activation or setting in service makes it also possible to determine the length of the cycles and the number of accrued hours of service of the equipment.

The out-of-service placement is carried out inversely and automatically: when the parameter or parameters, representative of the operation of the equipment, extend over or under a predetermined value or values, during a predefined time period, the device is automatically deactivated.

By way of example, the device is made operational when the equipment is subjected to a vibration level corresponding to an operation at a level of load beyond a determined level. The vibration triggering threshold can be at the level of amplitude measured in the area of the frequencies or even a combination of both. The vibration sensor is configured to detect at least one frequency range corresponding, for example, to a speed referred to as slowed down, or “idle”, of the equipment in order to determine each operation cycle.

The equipment can have one or more frequencies of its own when it is mounted on the aircraft in in operation. These own frequencies can be intrinsic to the equipment or result from vibrations coming from other equipment and transmitted to the equipment in question.

Preferably, it is the electric generator which ensures the activation or setting in service and deactivation of the device. Such a device shall thus have a very simple construction since it is the powering on which starts the measuring of the parameter or parameters of operation and the powering off which stops the measuring. The measurements intrinsically contain, in addition to information relative to the loads of operation of the equipment, information relative to the length of the cycles of operation and thus the number of accrued operation hours of the equipment.

The generator, whether it be thermal-based, vibration-based, or any other basis, can thus be calibrated to deliver a voltage or output current adequate for actuating the monitoring device only when the equipment is operating.

It is apparent that an invention with significant advantages has been described and illustrated. The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified, and all such variations are considered within the scope and spirit of the invention. Accordingly, the protection sought herein is as set forth in the description. Although the present application is shown in a limited number of forms, it is not limited to just these forms, but is amenable to various changes and modifications without departing from the spirit thereof.

We claim:

1. A monitoring device for aircraft equipment adapted to be taken on board on the equipment, comprising:
an energy source having a sufficient capacity for the device to function;
at least one sensor adapted to measure an operation parameter of the equipment;
electronic control means; and
a memory adapted to store the values measured by the sensor;
wherein the monitoring device is configured to be automatically activated only in the presence of one or more parameters representative of the operation of the equipment, in the absence of an electric or electronic connection with the outside of the monitoring device.

2. The monitoring device according to claim 1, wherein the parameter representative of the equipment operation comprises:
at least one of temperature and vibrations.

3. The monitoring device according to claim 1, further comprising:
a vibration sensor used as a parameter for activating the monitoring device, the sensor being preferably configured to detect at least one determined frequency range.

4. The monitoring device according to claim 1, further comprising:
a temperature sensor used as a parameter for activating the monitoring device.

5. The monitoring device according to claim 1, wherein the energy source comprises:
a thermo-generator.

6. The monitoring device according to claim 5, wherein the thermo-generator ensures the activation of the monitoring device based on a temperature parameter.

7. The monitoring device according to claim 5, further comprising:
a vibration sensor ensuring the activation of the monitoring device based on a vibration parameter.

8. The monitoring device according to claim 6, wherein the energy source further comprises:
a piezoelectric generator.

9. The monitoring device according to claim 1, further comprising:
connectors adapted to enable a transfer of information stored in the memory to an external apparatus.

10. The monitoring device according to the claim 9, wherein the monitoring device is passive in terms of wavelength transmission.

11. The monitoring device according to claim 1, further comprising:
a support for housing the components of the monitoring device.

12. The monitoring device according to claim 11, wherein the support comprises:
a visible metallic part adapted to receive an identification plate of the equipment.

13. The monitoring device according to claim 11, wherein the support comprises:
a surface for assembly on the equipment, the surface being metallic and directly supporting the sensor adapted to measure an operation parameter of the equipment, the sensor being selected from among temperature and vibration sensors.

14. An aircraft, comprising:
selected equipment; and
a monitoring device comprising:
an energy source having a sufficient capacity for the device to function;
at least one sensor adapted to measure an operation parameter of the selected equipment;
electronic control means; and
a memory adapted to store the values measured by the sensor;
wherein the monitoring device is configured to be automatically activated only in the presence of one or more parameters representative of the operation of the selected equipment, in the absence of an electric or electronic connection with the outside of the device.

15. The aircraft according to claim 14, wherein the selected equipment has at least one equipment frequency, and the monitoring device comprises:
a vibration sensor adapted to detect a frequency range inclusive of the equipment frequency.
